(19) United States
(12) Patent Application Publication
(10) Pub. No.: US 2015/0298214 A1
(43) Pub. Date: Oct. 22, 2015

(54) Pipe Beveler

(71) Applicant: REED MANUFACTURING COMPANY, Erie, PA (US)

(72) Inventor: Christopher M. Arkwright, Erie, PA (US)

(73) Assignee: REED MANUFACTURING COMPANY, Erie, PA (US)

(21) Appl. No.: 14/258,095

(22) Filed: Apr. 22, 2014

(51) Int. Cl. B23B 5/16

(52) U.S. Cl. CPC B23B 5/168; B23B 2215/72; B23B 2220/04; B23B 2226/61

(57) ABSTRACT

A pipe beveler for chamfering simultaneously the inside and outside of a pipe end is provided. The device may comprise a main body, at least two blades, and an arbor. The body includes an open-end cylindrical pipe guide portion and an internal frustoconical portion. The blades are firmly affixed to the main body with their cutting edges arranged at positions and angles that allow for chamfering simultaneously the inner and outer diameters of the pipe end. A spare blade may also be affixed inside the main body.

### BACKGROUND

This invention relates to pipe preparing tools, and more particularly to novel devices for chamfering simultaneously the inner and outer diameter of a plastic pipe end.

It is often necessary to chamfer the end of a plastic pipe prior to gluing or otherwise affixing the pipe to a coupling. In order to achieve a sound union between the pipe and coupling the pipe must be chamfered.

Deburring and chamfering the plastic pipe on the outer edge after it is cut allows the glue to glide between the fitting and the pipe. This outer chamfering prevents the glue from being completely pushed out of the joint as the pipe enters the coupling, and greatly reduces the chance of a leak at the coupling.

Deburring and chamfering water pipes on the inner edge reduces turbulence and prevents leftover cutting particles from getting washed into the small orifices in plumbing fixtures. On drain pipes, the inner chamfering/deburring prevents objects from catching on the pipe as the objects pass through the pipe.

It is an object of the present disclosure to provide a pipe beveler that will chamfer simultaneously the inner and outer diameter of a pipe end.

It is an object of the present disclose to provide a pipe beveler that includes a component for guiding the pipe in a stable manner into the bevel tool towards the bevel blades.

It is an object of the present disclosure to provide a pipe beveler that is stable, secure and safe during the chamfering process.

It is an object of the present disclosure to provide a pipe beveler that may be attached to a handheld drill for use.

It is an object of the present disclosure to provide a pipe beveler that removes only a fixed amount of material from a pipe.

It is an object of the present disclosure to provide a pipe beveler that may be used on more than one thickness schedule of pipe.

As used herein, the term “corner” may mean a sharp or rounded corner.

### BRIEF DESCRIPTION OF THE DRAWINGS

FIG. 1 shows a side cross-section an embodiment of the invention.

FIG. 2 shows a perspective view directed at the open pipe-receiving end of the embodiment of FIG. 1.

FIG. 3 shows a perspective view of directed at the arbor/drill attachment side of the embodiment of FIG. 1.

FIG. 4 shows an exploded view of an embodiment of FIG. 1.

FIG. 5A shows a straight view through of pipe being chamfered by the embodiment of FIG. 1.

FIG. 5B shows the B-B cross section view of FIG. 5A.

### DESCRIPTION OF EMBODIMENT

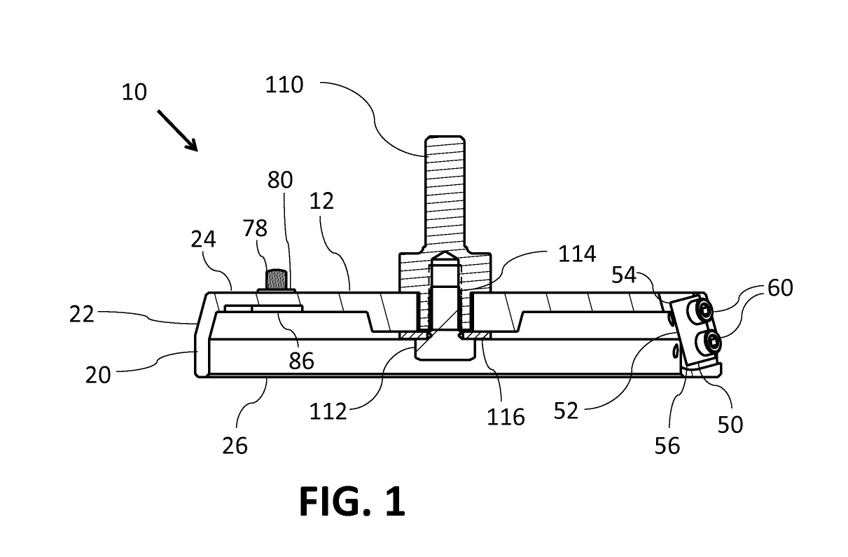

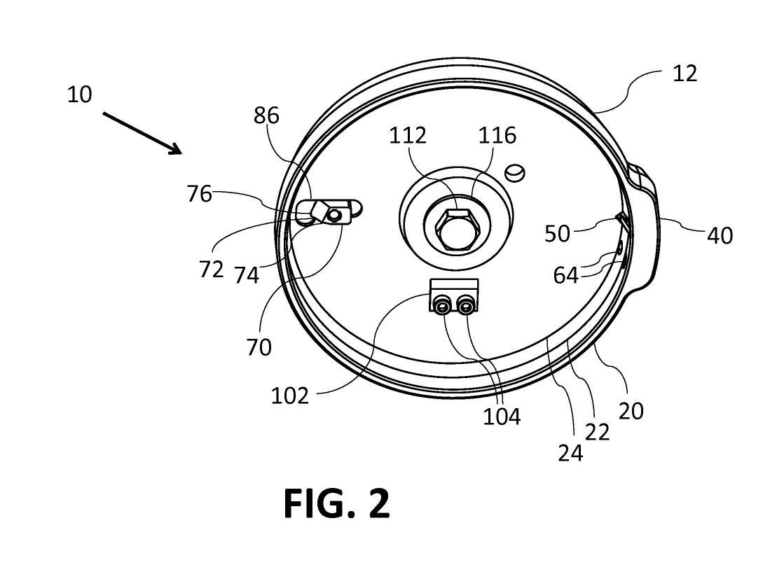

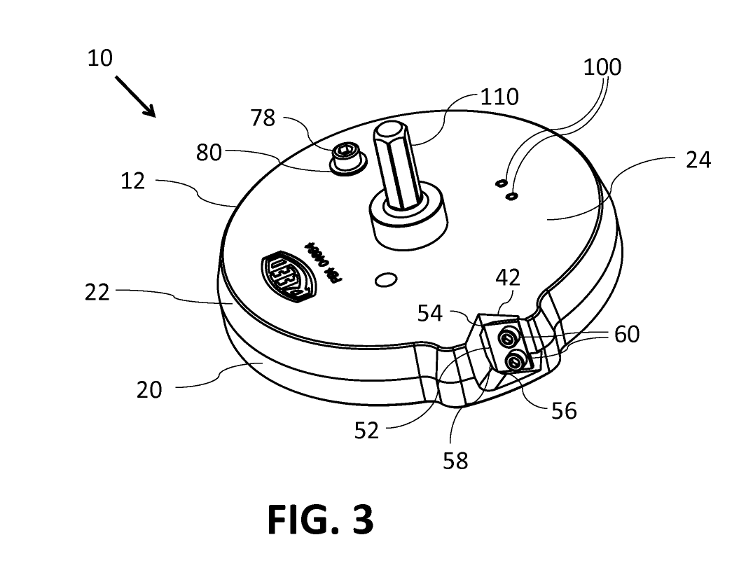

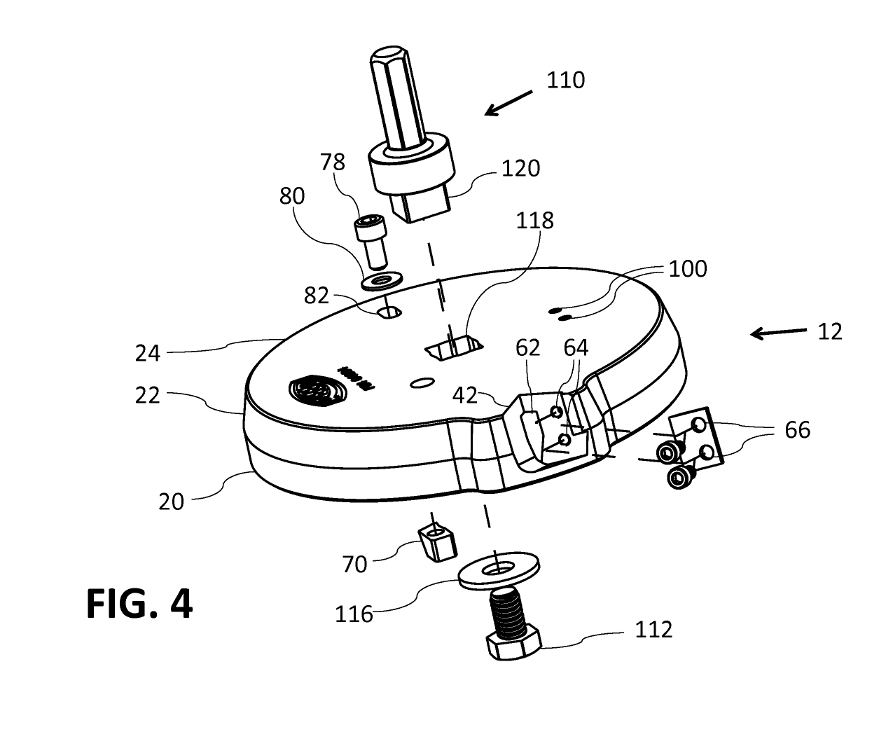

An embodiment of the pipe beveler 10 is shown in FIGS. 1-5B. In this embodiment, substantially all parts of the pipe beveler 10 may be made of metal but are interchangeable with other materials obvious to those skilled in the art.

The pipe beveler 10 includes a main body 12, a first blade 50, a second blade 70, a third blade 102, and an arbor 110.

Main body 12 includes a substantially cylindrical side 20 which is adjacent to a substantially frustoconical side 22, which is adjacent to closed side 24 that is substantially disc-shaped. Opposite to closed side 24 is open side 26, which is also substantially disc-shaped. Cylindrical side 20 has a predetermined inner diameter virtually identical to (but larger than) the outer diameter of the particular size of plastic pipe that will be beveled.

Frustoconical and cylindrical sides 22, 20 each lack a uniform outer diameter due to protrusion 40 that includes an angled recess 42.

First blade 50 has two holes 66 through which it may be affixed securely to angled recess 42 by two bolts 60 that are screwed and tightened into threaded holes 64. The length of aperture 58 at its longest point is virtually identical to (but of course larger than) the length of first blade 50 such that cutting edge 52 may be partially or completely inserted inside main body 12, but aperture 58 reduces in length where the first blade 50 is not present Thus, first blade is stabilized both by the two bolts 60 and the confining shape of aperture 58.

The width of aperture 58 is greater than the width of first blade 50, in order to allow for pipe peelings to escape beveler through the aperture 58 during use.

First blade 50 is arranged such that cutting edge 52 is substantially parallel with the inner diameter of frustoconical side 22. However, the first blade cutting edge top and bottom corners 54, 56 are always arranged such that the bottom corner does not extend towards the center of the main body further than the second blade bottom corner 76. Put another way, if the inner diameter of cylindrical side 20 were to define the sides of a cylinder of infinite length, then the top corner 54 would be further from this infinite cylinder than the bottom corner 56.

Also inside the main body, 12, second blade 70 rests in recess 86 that is longer that second blade 70 such that second blade 70 may be moved closer to, or further from, the inner diameter of frustoconical side 22 but is fixed horizontally. Bolt 78 goes through washer 80 and slot 82 and affixes second blade 70 to the inside of closed side 24 when bolt is screwed and tightened into threaded hole 84. In this embodiment, slot 82 is a predetermined length such that securing the bolt 78 at the slot end nearest the frustoconical side will result in positioning cutting edge 72 optimally for beveling the inner diameter of a SCH 40 thickness pipe; likewise, securing bolt 78 at the slot end nearest the center of closed side 24 will result in positioning cutting edge 72 optimally for beveling the inner diameter of a SCH 80 thickness pipe. Of course, other embodiments may be arranged in a predetermined manner, by means obvious to those with ordinary skill in the art, to shave pipes of other varying thicknesses and sizes.

Although the angle of second blade cutting edge 72 may vary, the cutting edge 72 always slopes toward the center the further away it is from the closed side 24, such that the top corner 74 is always further away from the frustoconical side 22 than the bottom corner 76 is away from the frustoconical side. Similarly, if the inner diameter of cylindrical side 20 were to define the sides of a cylinder of infinite length, then the bottom corner 76 would always be closer to this infinite cylinder than the top corner 74.

A third blade, e.g., spare blade 102, may be affixed to the inside of closed side 24 with two bolts 104 going though and being screwed and tightened into threaded holes 100. In this embodiment the spare blade 70 can replace the first blade 50 but a similar spare blade for the second blade 70 could in theory be affixed to the beveler as well. The spare blade 70 is positioned far enough away from the frustoconical side 22 so as to not contact any pipe during operation of the device or otherwise interfere with the beveler during use.

Arbor 110 is secured to main body 12 by placing arbor block 120 in corresponding hole 118 and affixing washer 116 in between closed side 24 and bolt 112, by screwing and tightening bolt 112 into threaded hole 114.

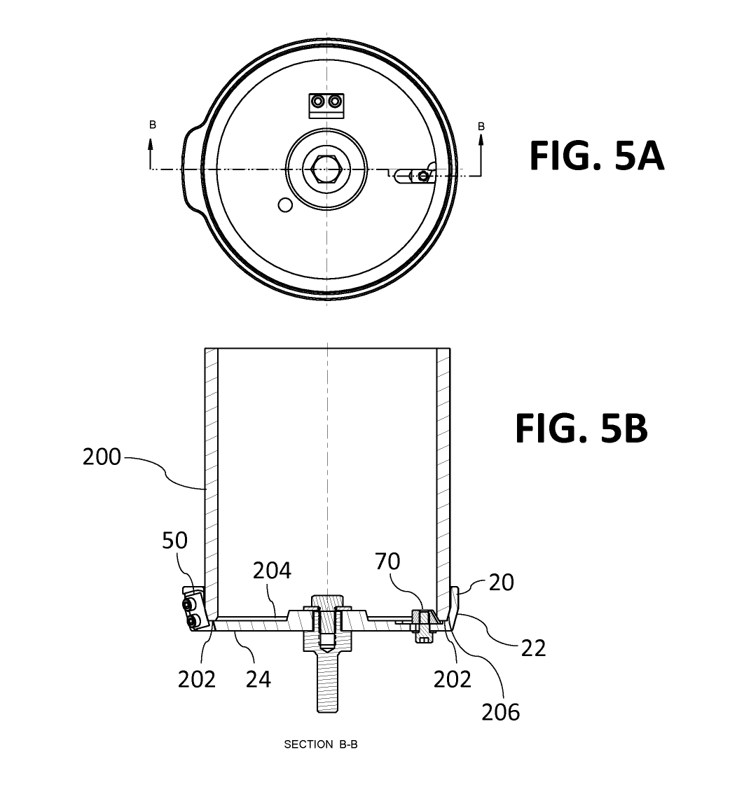

A use of the embodiment will now be described. First, beveler 10 is affixed to a rotational power source, such as a hand-held drill, by affixing arbor 110 to the drill. Use of the embodiment on a plastic pipe is shown in FIGS. 5A and 5B. Beveler 10 is positioned by placing open side 26 and a portion of cylindrical side 20 over the end of a pipe 200 to be beveled. The rotational power source is then turned on, and the user may press the beveler against the pipe end 202. As the beveler is pressed forward, first blade 50 acts to shave the outside diameter of the pipe end 202, while second blade 70 acts to shave the inside diameter of the pipe end 202. The internal diameter chamfering can be seen at 204 while the external diameter chamering is shown at 206.

The user will know the beveling process is finished when the beveler 10 cannot be pushed forward further; at the final stage as shown in FIG. 5B the beveler may not be pressed forward because pipe end 202 is pressed against closed side 24. The beveler is similarly is prevented from moving substantially side-to-side because of the constricting shape of cylindrical side 20 and frustoconical side 22.

Various changes, alternatives, and modifications will become apparent to a person of ordinary skill in the art after a reading of the foregoing specification. It is intended that all such changes, alternatives, and modifications as fall within the scope of the appended claims be considered part of the present invention.

I claim:

1. A pipe beveler, comprising:
(A) a main body, wherein said main body includes:
(a) an open side, wherein said open side is substantially circular;
(b) a closed side, wherein said closed side is substantially circular;
(c) a hollow substantially frustoconical side;
(d) a hollow substantially cylindrical side, wherein the inner diameter of said cylindrical side defines the sides of an infinite length cylinder;
(e) an aperture;
wherein
(a) said open side is opposite to and parallel to said closed side;
(b) said open side is adjacent and contiguous to said cylindrical side;
(c) said cylindrical side is adjacent and contiguous to said frustoconical side;
(d) said frustoconcial side is adjacent and contiguous to said closed side; and
(e) said aperture is located on said frustoconical and cylindrical side;
(B) a first blade and a second blade, wherein
(a) said first blade has a cutting edge, wherein said first blade cutting edge includes a top corner and a bottom corner;
(b) said second blade has a cutting edge, wherein said second blade cutting edge includes a top corner and a bottom corner;
(c) said first blade is affixed at least to said frustoconical side;
(d) a portion of said first blade is located outside said main body;
(e) said first blade cutting edge is located inside said main body;
(f) said first blade cutting edge is parallel to an adjacent portion of said frustoconical side;
(g) the greatest length of said aperture is virtually identical to the length of said first blade cutting edge;
(h) the width of said aperture is greater than the width of said first blade;
(h) said second blade is affixed to said closed side;
(i) said second blade cutting edge is located inside said main body;
(j) said bottom corner of said second blade cutting edge is adjacent said closed side;
(k) said second blade cutting edge bottom corner is a first distance from said infinite cylinder side;
(l) said second blade cutting edge top corner is a second distance from said infinite cylinder side; and
(m) said first distance is less than said second distance.

2. The beveler of claim 1, wherein
(a) said first blade cutting edge top corner is a third distance from said infinite cylinder side;
(b) said first blade cutting edge bottom corner is a fourth distance from said infinite cylinder side; and
(c) said third distance is greater than said fourth distance.

3. The beveler of claim 2, wherein said fourth distance is less than said second distance.

4. The beveler of claim 1, further comprising:
(A) a first bolt that has a head and a shank;
(B) a slot having a uniform width and a uniform length, and a uniform depth extending orthogonally through said closed side;
(C) a recess on said closed side inside said main body; and
(D) a threaded hole in said second blade;
wherein
(a) the entire said width and said length of said slot is adjacent to said recess;
(b) said second blade is at least partially inside said recess;
(c) a width of said second blade is virtually identical to, but less than, a width of said recess; and
(d) a length of said second blade is less than a length of said recess.

5. The beveler of claim 4, wherein
(a) said bolt shank extends through said slot and into said second blade threaded hole;
(b) said slot length is less than said recess length;
(c) said slot width is less than said recess width; and
(d) said bolt head is adjacent to said closed side outside said main body.

6. The beveler of claim 1, wherein said first blade is affixed to said main body by at least two bolts, wherein said two bolts are least partially located outside said main body.

7. The beveler of claim 1, further comprising an arbor, wherein said arbor is affixed to said closed side outside said main body.

8. The beveler of claim 1, further comprising a third blade, wherein
(a) said third blade is identical in size and shape to said first blade; and
(b) the shortest distance between said third blade and said infinite cylinder is greater than said second distance.

8. A pipe beveler, comprising:
(A) a main body that includes an inside, an outside, and an aperture;
(B) a first blade and second blade that each include a cutting edge, a cutting edge top corner and a cutting edge bottom corner; and
(C) an arbor;
wherein
(a) said inside includes a substantially cylindrical surface, a substantially frustoconical surface, and a substantially circular surface;
(b) said circular surface is adjacent and contiguous to said frustoconical surface, such that the diameter of said circular surface is identical to the shortest diameter of said frustoconical surface;
(c) said frustoconcial surface is adjacent and contiguous to said cylindrical surface, such that the greatest diameter of said frustoconical surface is identical to the diameter of said cylindrical surface;
(d) said cylindrical surface defines the sides of an infinite length cylinder;
(e) said aperture is located on said cylindrical and frustoconical surfaces;
(f) said first and second blade cutting edges are located in said inside;
(g) said first blade cutting edge is parallel to an adjacent portion of said frustoconical surface;
(h) all of said first blade cutting edge is closer to said infinite cylinder than any of said second blade cutting edge is to said infinite cylinder;
(i) said second blade is adjacent to and affixed to said circular surface;
(j) said arbor is affixed to said outside;
(k) said first blade is at least partially located inside said aperture;
(l) said second blade cutting edge bottom corner is adjacent to said circular surface;
(m) said second blade cutting edge bottom corner is closer to said infinite cylinder than said second blade cutting edge top corner is to said infinite cylinder; and
(n) said first blade is at least partially located on said outside.

9. A method for chamfering simultaneously the inside and outside diameter of a plastic pipe end, said method comprising:
(A) manufacturing a main body that includes an outside and an open hollow inside, wherein said inside includes a substantially cylindrical surface, a substantially frustoconical surface, and a substantially circular surface, wherein said circular surface is adjacent and contiguous to said frustoconical surface which is adjacent and contiguous to said cylindrical surface;
(B) creating an aperture completely through said main body such that an end of said aperture is located on said cylindrical and frustoconical surfaces;
(C) affixing a first blade to said main body with two bolts, such that a cutting edge of said first blade is located inside said main body, a portion of said first blade is located inside said aperture, and a portion of said first blade and a portion of said two bolts are located outside said main body;
(D) positioning said first blade cutting edge parallel with an adjacent portion of said frustoconical surface;
(E) affixing a second blade inside a recess that is located on said circular surface;
(F) positioning a cutting edge of said second blade such that a bottom corner of said second blade is adjacent to said circular surface and such that a top corner of said second blade is further from said frustoconical surface that said bottom corner is from said frustoconical surface;
(G) affixing an arbor to the outside of said main body with an arbor bolt, such that the head of said arbor bolt is located at the center of said circular surface;
(H) coupling a power drill to said arbor;
(I) placing said cylindrical surface around a pipe that has a diameter virtually identical to, but less than, said cylindrical surface;
(J) turning on said drill; and
(K) pressing said drill forward toward pipe until an end of said pipe is in contact with said circular surface.
